(19) United States
(12) Patent Application Publication
(10) Pub. No.: US 2011/0222721 A1
(43) Pub. Date: Sep. 15, 2011

(54) CONNECTING MEMBER FOR SPEAKER AND SPEAKER

(75) Inventors: Kyoichi Matsuda, Tendo (JP); Seiya Sato, Tendo (JP); Takuei Nagasawa, Tendo (JP); Kenichi Oshima, Tendo (JP)

(73) Assignees: PIONEER CORPORATION, Kawasaki-shi, Kanagawa (JP); TOHOKU PIONEER CORPORATION, Tendo-shi, Yamagata (JP)

(21) Appl. No.: 13/126,815

(22) PCT Filed: Oct. 31, 2008
(86) PCT No.: PCT/JP2008/069922

§ 371 Date: Apr. 29, 2011

(51) Int. Cl. H04R 1/00

(52) U.S. Cl. 381/412

(57) ABSTRACT

A connecting member for speaker purpose, which is prevented from peeling easily from both a voice coil support and a vibrating body, and a speaker having the connecting member are provided. The speaker 1 includes a frame 4 and a vibrating unit 3. The vibrating unit 3 includes a drive cone 14 vibrated by a magnetic circuit unit 2, and a connecting member for speaker purpose 19. The connecting member for speaker purpose 19 connects the drive cone 14 and a voice coil bobbin 13 supporting a voice coil 12. The connecting member for speaker purpose 19 includes a member main body 40 formed into a ring shape and mounted at an outer surface of the voice coil bobbin 13; and a U-shape groove 41 arranged at the member main body 40 and receiving an insert cylinder portion 33 arranged at an inner edge of the drive cone 14.

### FIELD OF THE INVENTION

The present invention relates to a connecting member for speaker connecting a voice coil support part and a vibrating body of a speaker, which generates a sound by a diaphragm vibrated by voice currents being supplied, and a speaker including the connecting member for speaker.

### DESCRIPTION OF THE BACKGROUND ART

Various speakers are mounted generally on a vehicle as a moving body (for example, shown in Patent Document 1 and Patent Document 2). The speakers shown in Patent Document 1 and Patent Document 2 include a frame, a vibration unit arranged in the frame, and a magnetic circuit unit mounted at the frame and vibrating the vibration unit so as to generate a sound.

The vibration unit includes a voice coil, which voice currents is supplied to; a voice coil bobbin, which the voice coil is arranged at, as a voice coil support part; a cone-shaped diaphragm connected with the voice coil bobbin as a vibrating body; and a connecting member for speaker connecting the voice coil bobbin and the diaphragm. The magnetic circuit unit includes a permanent magnet in a magnetic gap, and the voice coil is positioned in the magnetic gap.

In the speaker configured as mentioned above, the voice currents is supplied to the voice coil and thereby electromagnetic force (Lorentz force) is exerted to the voice coil and the diaphragm is vibrated and a sound generates according to the voice currents.

The above-mentioned connecting member for speaker is formed into a circular and annular-shaped plate, and connected to an outer surface of the voice coil bobbin by an adhesive. An inner edge of the diaphragm is connected to the connecting member for speaker by an adhesive.

### CITATION LIST

Patent Document 1: Japan Patent Publication Application H01-200922
Patent Document 2: Japan Patent Publication Application S57-74599

### SUMMARY OF THE INVENTION

### Object to be Solved

In recent years, the above-mentioned speaker is required to be thinner. For make the speaker thin, a cone-shape diaphragm is generally required to be flatter, and thereby, an angle between an outer edge of the diaphragm and an outer surface of the voice coil bobbin is required to be larger. In case that the angle is larger, a peeling force caused by the vibration, acting so as to peel the connecting member for speaker from the outer surface of the voice coil bobbin, becomes larger than that in case that the above angle is small.

In the above conventional speaker, the connecting member for speaker is formed into a circular and annular-shaped plate, so that a connecting area between the connecting member for speaker and the voice coil bobbin and a connecting area between the connecting member and the diaphragm are small. Thereby, in case that the peeling force, generated by vibration of the diaphragm, acting so as to peel the connecting member for speaker from the outer surface of the voice coil bobbin, becomes larger, the above adhesive is easily broken, and the connecting member for speaker is easily peeled from the voice coil bobbin or the diaphragm. Especially, when the diaphragm is vibrated with a large amplitude of vibration in the long term, the connecting member for speaker may be peeled from the voice coil bobbin or the diaphragm. In the worst case, the vibration from the voice coil bobbin is not transmitted to the diaphragm.

According to the above problem, an object of the present invention is to provide a connecting member for speaker, which connecting member is not easily peeled from both of a voice coil support part and a vibrating body, and a speaker including the connecting member for speaker.

### Means for Solving the Problems

In order to solve the above problem and achieve the object of the present invention, a connecting member for speaker of the present invention described in claim 1, connecting a vibrating body vibrated with a magnetic circuit unit to a voice coil support part supporting a voice coil, includes a member main body formed into a annular shape and connected to at an outer face of the voice coil support part; and a U-shaped groove arranged at the member main body, in which an inner edge part of the vibrating body is arranged.

### BRIEF DESCRIPTION OF THE DRAWINGS

FIG. 1 is a cross-sectional view of a speaker including a connecting member for speaker of a first embodiment according to the present invention;

FIG. 2 is a perspective view of the connecting member for speaker of the speaker shown in FIG. 1;

FIG. 3 is a plan view of the connecting member for speaker shown in FIG. 2;

FIG. 4A is a cross-sectional view of the connecting member for speaker taken along the line IVA-IVA shown in FIG. 3;

FIG. 4B is an expanded cross-sectional view by expanding IVB area shown in FIG. 1;

FIG. 5 is a perspective view of the voice coil bobbin of the speaker shown in FIG. 1;

FIG. 6 is a plan view of the connecting member for speaker and a voice coil bobbin of the speaker shown in FIG. 1;

FIG. 7 is a perspective view of a drive cone of the speaker shown in FIG. 1;

FIG. 8 is a plan view of the drive cone shown in FIG. 7;

FIG. 9 is a cross-sectional view of the drive cone taken along the line IX-IX shown in FIG. 8;

FIG. 10 is a plan view of a diaphragm and a center cap of the speaker shown in FIG. 1;

FIG. 11 is a plan view of the connecting member for speaker according to a second embodiment of the present invention;

FIG. 12 is an expanded cross-sectional view of a main area of the speaker including the connecting member for speaker shown in FIG. 11;

FIG. 13 is a plan view of the drive cone according to a third embodiment of the present invention;

FIG. 14 is an expanded cross-sectional view of a main area of the speaker including the drive cone shown in FIG. 13;

FIG. 15 is a cross-sectional view of the speaker as a modification example of the present invention;

FIG. 16A is an expanded cross-section view of a main area of a modified example of the connecting member shown in FIG. 4B;

FIG. 16B is an expanded cross-section view of a main area of another modified example of the connecting member shown in FIG. 4B; and

FIG. 17 is an illustration of a vehicle including a speaker according to the present invention.

### LIST OF MARKS

1 Speaker
2 Magnetic circuit unit
4 Frame
7 Yoke
8 Magnet
9 Plate
12 Voice coil
13 Voice coil bobbin (Voice coil support part)
14 Drive cone (drive member, vibrating body)
15 Diaphragm (vibrating body)
16 Center cap (Second vibrating body)
17 Edge
18 Second edge
19 Connecting member for speaker
28 Lead wire
29 Through hole
30 Upward extending part (inner periphery part)
31 Turning part
32 Downward extending part (outer periphery part)
34 Groove for receiving a diaphragm (support portion)
40 Member main body
41 U-shaped groove
42 Projection part
43 Bottom face part
44 Inner wall part
45 Outer wall part
46 Flange part
47 Adhesive
48 Adhesive
P Vibrating direction
Q Intersecting direction
θ1 Angle of the upward extending part
θ2 Angle of the downward extending part
K Space (enclosed space)

### DESCRIPTION OF THE PREFERRED EMBODIMENT

One embodiment according to the present invention will be described as follows. A connecting member for speaker according to the one embodiment of the present invention is provided with a U-shaped groove in which an inner edge part of a vibrating body is arranged, so that a thickness of apart of the connecting member for speaker, which a voice coil support part is connected to, can be made thicker than that of a conventional connecting member. Thereby, a contact area between the inner edge part of the vibrating body and the connecting member for the speaker can be increased. The connecting member is not easily peeled from both of the voice coil support part and the vibrating body. Thus, vibration of the voice coil support part can be securely transmitted to the vibrating body.

A projection part projecting toward the voice coil support part from an inner face of a member main body, at which the U-shaped groove is arranged, may be arranged. In the case, the projection parts may be preferably arranged in similar intervals in a circumferential direction of the member main body. Thereby, the connecting member for speaker can be connected to the voice coil support part so as to align the voice coil support part and the connecting member for speaker coaxially to each other. The connecting member for speaker can be connected preventing from tilting against the voice coil support part.

A height of an inner wall part from a bottom face part of the member main body may be formed to be higher than a height of an outer wall part of the member main body. In the case, a contact area between the inner wall part and the voice coil support part can be increased, so that the connecting member for speaker can be more securely connected with the voice coil support part. The height of the outer wall part is shorter than the height of the inner wall part. Even when the vibrating body is vibrated by the speaker driving and the inner edge part of the vibrating body is deformed, the vibrating body can be prevented from contacting with a part other than the U-shaped groove of the connecting member for speaker. Therefore, a thin flat-type speaker can be provided.

A flange part extending in a direction toward an outer periphery part from an outer edge part of the bottom face part and projecting from an outer face of the outer wall part may be provided. Thereby, stiffness of the member main body, that is the connecting member for speaker, can be increased. Therefore, the connecting member for speaker may not be deformed during vibrating of the voice coil support part, and the vibration of the voice coil support part can be securely transmitted to the vibrating body. When the speaker is in an unusual condition, the flange part maybe easily contacted to the magnetic circuit unit or the frame. Thereby, an abnormal sound is generated by contacting the flange part to the magnetic circuit unit or the frame and warning is raised to a user with the abnormal sound.

In the embodiment a speaker may include the connecting member for the speaker having the structure as mentioned above. In the speaker, a lead wire from the inner face of the member main body of the connecting member for speaker may be passed through an interval between the projection parts, or may be also passed an interval between an outer face of the voice coil support part and the inner wall part of the connecting member for speaker. The voice coil may be arranged at one end part of the voice coil support part, and the lead wire can be led out toward another end part of the voice coil support part, that is the connecting member for speaker. In these cases, the connecting member for speaker can be prevented from peeling from both of the voice coil support part and the vibrating body, so that the vibration of the voice coil support part can be securely transmitted to the vibrating body.

The inner wall part of the connecting member for speaker and the outer face of the voice coil support part can be connected by a known adhesive made of resin. In this case, the voice coil support part and the connecting member for speaker are configured as different components, so that Joule heat generated at the voice coil can be prevented from easily transmitting to the vibrating body. By using a known adhesive with a relatively small thermal conductivity, the Joule heat is prevented from easily transmitting to the vibrating body, so that connection strength between the connecting member for speaker and the vibrating body can be maintained.

A through hole between the voice coil support parted by the voice coil support part and the connecting member for speaker may be provided. Thereby, the voice coil and the voice coil support part can be cooled and the Joule heat generated at the voice coil is prevented from transmitting to the vibrating body, so that a connection strength between the voice coil support part and the connecting member for speaker and the connection strength between the connecting member for speaker and the vibrating body can be maintained.

The connecting member for speaker can be constructed with a material different from materials of the vibrating body and the voice coil support part. In the case, the Joule heat generated at the voice coil is prevented from transmitting to the vibrating body, so that the connection strength between the voice coil support part and the connecting member for speaker and the connection strength between the connecting member for speaker and the vibrating body can be maintained.

The connecting member for speaker and the vibrating body can be connected by an adhesive filled in the U-shaped groove. In the case, the connecting member for speaker and the vibrating body can be more securely connected.

The vibrating body to be connected with the connecting member for speaker may be formed as a diaphragm. In the case, the connecting member for speaker and the diaphragm can be more securely connected.

The vibrating body to be connected with the connecting member for speaker can be formed as a drive member. In the case, the connecting member for speaker and the drive member can be more securely connected.

The magnetic circuit unit can be configured by a plate, a magnet and a yoke. In the case, the magnet circuit can securely vibrate the vibrating body.

A part of the drive member between an inner periphery part and an outer periphery part may support the diaphragm of the drive member. In the case, the vibration of the voice coil support part can be transmitted to the diaphragm via the drive member.

An inner edge part of the drive member may be arranged at a position, which is farther than a position of an outer edge part of the drive member from the magnetic circuit unit. In the case, an interval between the outer edge part of the drive member and the diaphragm can be increased, so that an amplitude of vibration of the diaphragm can be increased.

In the drive member, the diaphragm may be supported by a turning part flat in a direction perpendicular to the vibrating direction and arranged between the inner periphery part and the outer periphery part of the drive member. In the case, the vibration of the voice coil support part can be transmitted to the diaphragm via the drive member.

An angle between an upward extending part of the drive member and a direction perpendicular to the vibrating direction of the drive member may be smaller than an angle between a downward extending part of the drive member and the direction perpendicular to the vibrating direction of the drive member. In the case, total thickness of the upward portion and the magnet circuit unit overlapped in the vibrating direction can be decreased, so that the speaker can be made thinner.

A second diaphragm, which is surrounded by the diaphragm and an outer edge part thereof is supported by the turning part, may be provided. In the case, it can be prevented that the voice coil support part is exposed, so that it can be prevented that dust and dirt stick to the voice coil support part.

An enclosed space among the drive member, the diaphragm and the frame may be provided. In the case, a gas in the enclosed space can damp the vibration of the vibrating member, so that a damper provided in a conventional speaker is not required. Therefore, a structure of the speaker can be simplified.

### First Embodiment

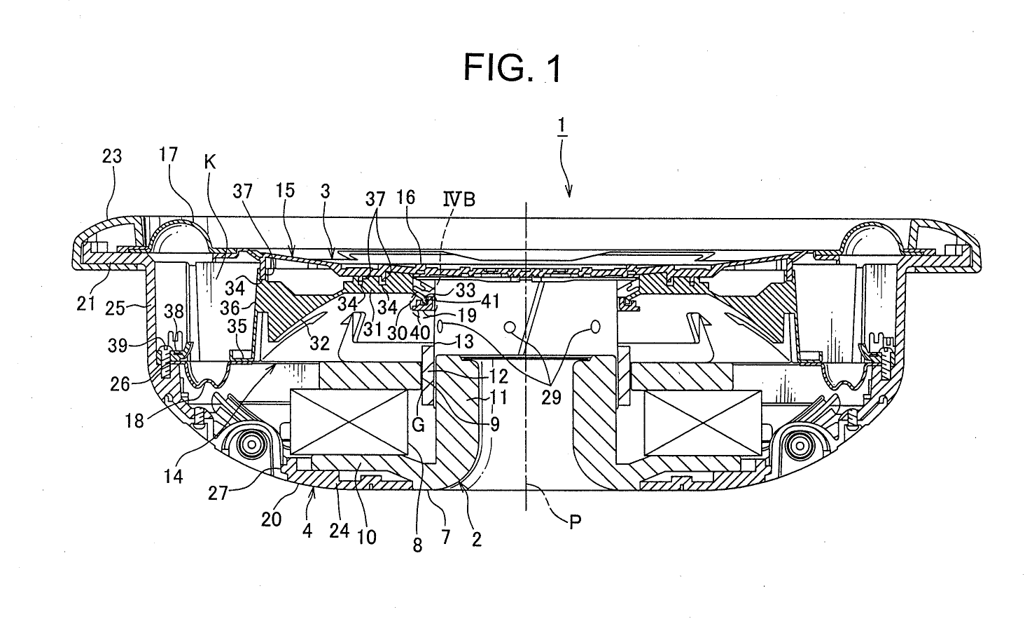

A first embodiment of the present invention is described with reference to FIGS. 1-10 and 17. A speaker 1 according to the first embodiment of the present invention as shown in FIG. 1 is arranged at a vehicle 100 as a moving body shown in FIG. 17, and provides audio information to a crew in the vehicle 100.

The speaker 1 as shown in FIG. 1 includes a frame 4, a magnetic circuit unit 2 and a vibrating unit 3 generating sound.

The frame 4 includes a frame main body 20 and a gasket 23 as shown in FIG. 1.

The frame main body 20 is configured by a metal such as aluminum. The frame main body 20 includes a circular and annular-shaped bottom part 24, a tubular part 25 formed cylindrically so as to extend raised from an outer edge part of the bottom part, a step part 26 projecting from an inner face (inner side face or inner periphery face) of the tubular part 25 and a flange part 21 extending outwardly from an edge part of the tubular part 25 at a side far from the bottom part 24. An opening part 27 passing through the frame main body 20 is arranged between the tubular part 25 and the bottom part 24. A plurality of opening parts 27 are formed at the bottom part 24 and the tubular part 25 of the frame main body 20 in intervals in a circumferential direction of the frame main body 20.

The step part 26 is formed into a circular and annular-shape so as to project toward an inside of the tubular part 25 from the inner face of the tubular part 25. The step part 26 is provided along the inner face of the tubular part 25 fully around the tubular part 25. The step part 26 is formed to be flat in a direction perpendicular to a later-described vibrating direction P.

The flange part 21 is formed into a circular and annular-shape so as to surround fully around the frame main body 20. The flange part 21 is formed to be flat in the direction perpendicular to the vibrating direction P.

The gasket 23 is formed into a circular and annular-shape. The gasket 23 is formed to have a cross-section substantially C-shaped and opening in the side of the inner periphery. The gasket 23 covers the flange part 21 of the frame main body 20 so as to sandwich a later-described edge 17 between the flange part 21 and the gasket. The gasket 23 is fixed to the frame main body 20 without a known adhesive, or with a known adhesive. By sandwiching the edge 17 between an outer edge part of the frame main body 20 and the gasket 23, a later-described diaphragm 15 is fixed in respect with the frame main body 20.

The magnetic circuit unit 2 is fixed to the frame main body 20 so as to be mounted to the frame 4. The magnetic circuit unit 2, as shown in FIG. 1, includes a yoke 7 formed with a magnetic body (i.e. ferromagnetic body), a magnet 8, and a plate 9 formed with a magnetic body (i.e. ferromagnetic body). The magnetic circuit is an outer-magnet type magnetic circuit including the yoke having a circular and annular shaped bottom plate 10 and a cylindrical-shaped center pole 11 extending raised from an inner edge part at a central area of the bottom plate 10. In this embodiment, the outer-magnet type magnetic circuit is described, however, according to the present invention, an inner-magnet type magnetic circuit and inner-outer-magnet type magnetic circuit (magnets are arranged respectively inside and outside a voice coil bobbin in the magnetic circuit) may be applied. In this embodiment, an opening part communicating to an outside of the speaker 1 is provided at the center pole 11, but no opening part may be arranged according to the present invention.

The magnet 8 is formed into a circular and annular shape. An inner diameter of the magnet 8 is larger than an outer diameter of the center pole 11. The magnet 8 is placed on the bottom plate 10. The center pole 11 is placed inside the magnet. The magnet 8 may be a permanent magnet or an electromagnet exited by a direct current power source.

The plate 9 is formed into a circular and annular shape. An inner diameter of the plate 9 is larger than the outer diameter of the center pole 11. The plate 9 is placed on the magnet 8. The center pole 11 of the yoke 7 and a later-described voice coil bobbin 13 are placed inside the plate 9. The yoke 7, the magnet 8 and the plate 9 are arranged coaxially so that the centers thereof are similar each other. Therefore, intervals are provided between inner face of the magnet 8 and an outer face of the center pole 11, and between the inner face of the plate 9 and an outer face of the center pole 11.

The plate 9 above mentioned is fixed to the frame main body 20 by a not-shown bolt passing through the bottom plate 10, the magnet 8 and the yoke 7 or a known adhesive. Thus, the magnetic circuit unit 2 is fixed to the frame 4. In short, the yoke 7, the magnet 8 and the plate 9 are arranged coaxially with respect to the frame 4.

By configuration above mentioned, the magnetic circuit unit 2 forms a magnetic gap G having relatively large magnetic flux density between the outer face of the center pole 11 of the yoke 7 and the inner face of the plate 9. Therefore, the magnetic circuit unit 2 vibrates the diaphragm 15 by generating electromagnetic force (Lorentz force) acted on a voice coil 12 in the magnetic gap G.

The vibrating unit 3 is received in the frame main body 20 of the frame 4. The vibrating unit 3 includes the voice coil 12, a voice coil bobbin 13 as a voice coil support part, a drive cone 14 as a drive member, the diaphragm 15, a center cap 16 as a second diaphragm, an edge 17, a second edge 18 and a connecting member for speaker 19.

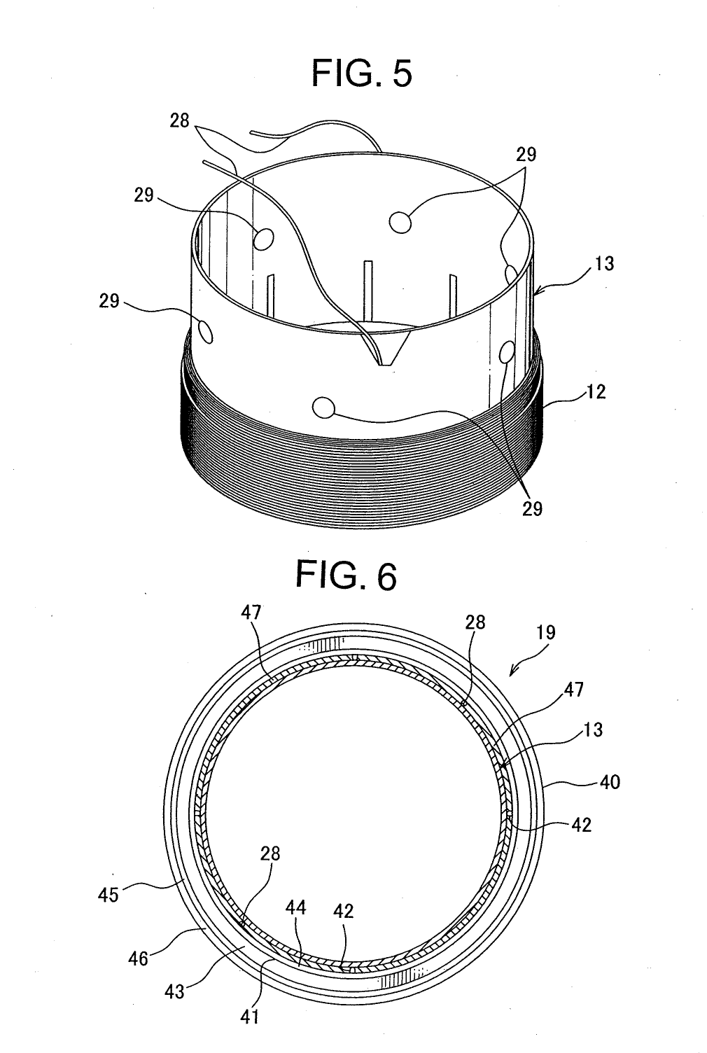

The voice coil 12 is wound at one end of the voice coil bobbin 13 around an outer face of the voice coil bobbin 13. The voice coil 12 is arranged in the above-mentioned magnetic gap G of the magnetic circuit unit 2 before the diaphragm is driven. Lead wires 28 (shown in FIG. 5) led from the voice coil 12 are provided at both ends of the voice coil 12 to be connected respectively with not-shown tinsel wires. The lead wires 28 are led from the voice coil 12 toward the other end of the voice coil bobbin 13 i.e. the connecting member for speaker 19 through a space between the outer face of the voice coil bobbin 13 and the inner face of the connecting member for speaker 19, that is a space between later-described inner wall parts 44, shown in FIG. 6. The lead wires 28 are further led through a space between later-described projection parts 42 of the connecting member for speaker 19. Voice currents are supplied to the voice coil 12 via the lead wires 28 and the tinsel wires.

The voice coil bobbin 13 is formed into a cylindrical shape. An inner diameter of voice coil bobbin 13 is formed larger than the outer diameter of the center pole 11 of the yoke 7. An outer diameter of the voice coil bobbin 13 is formed smaller than the inner diameters of the plate 9 and the magnet 8. The voice coil bobbin 13 is arranged coaxially with respect to the yoke 7, the plate 9 and the voice coil 12. The one end part of the voice coil bobbin, around the outer face of which the voice coil 12 is provided, is arranged in the magnetic gap G. The voice coil bobbin 13 is supported movably along a center axis of the yoke 7 by the drive cone 14 and the diaphragm 15. The center axes of the voice coil bobbin 13 and the yoke 7 substantially correspond to the center axis of the speaker 1. A plurality of through holes 29 is provided at the voice coil bobbin 13 as shown in FIG. 5. The through hole 29 penetrates through the voice coil bobbin 13 and is arranged between the one end part and the other end part of the voice coil bobbin 13, that is between the voice coil 12 and the connecting member for speaker 19. In the embodiment, the through holes 29 of six are provided at intervals in the circumferential direction of the voice coil bobbin.

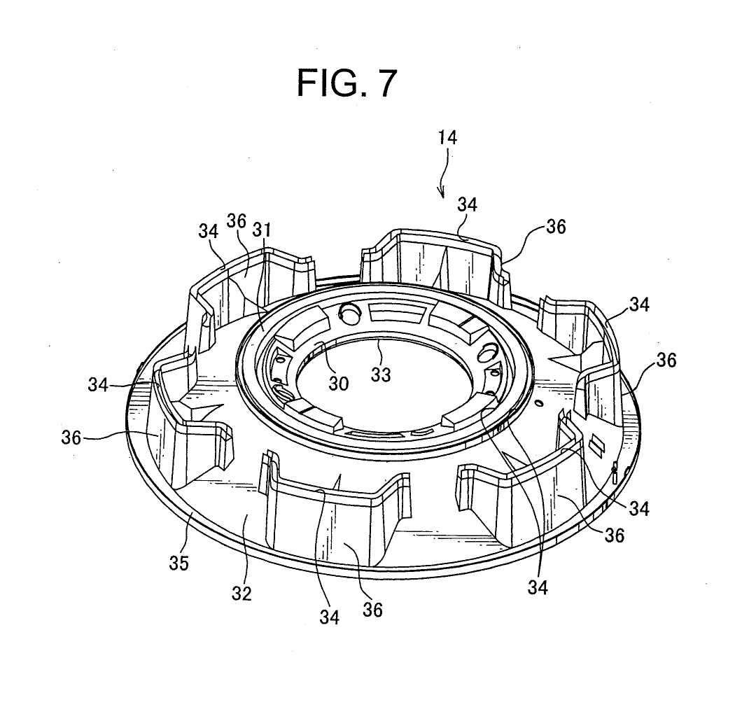

The drive cone 14 transmits vibration of the voice coil 12 to the later-described diaphragm 15. The drive cone 14 is formed with resin. The drive cone 14 is formed as a whole into a truncated cone shape as shown in FIG. 7. An inner edge part of the drive cone 14 is connected via the connecting member for speaker 19 with an outer face of the other end part in a center axis direction of the voice coil bobbin 13. Thus, the drive cone 14 is connected via the connecting member for speaker 19 and the voice coil bobbin 13 to the voice coil 12. The elastic and deformable second edge 18 formed into a flat and ring shape is connected to an outer edge part of the drive cone 14 by adhesive or the like. The second edge 18 can be connected to the drive cone 14 by a known method such as screwing or sewing other than adhesive. The drive cone 14 is supported via the second edge 18 by the step part 26 of the frame 4.

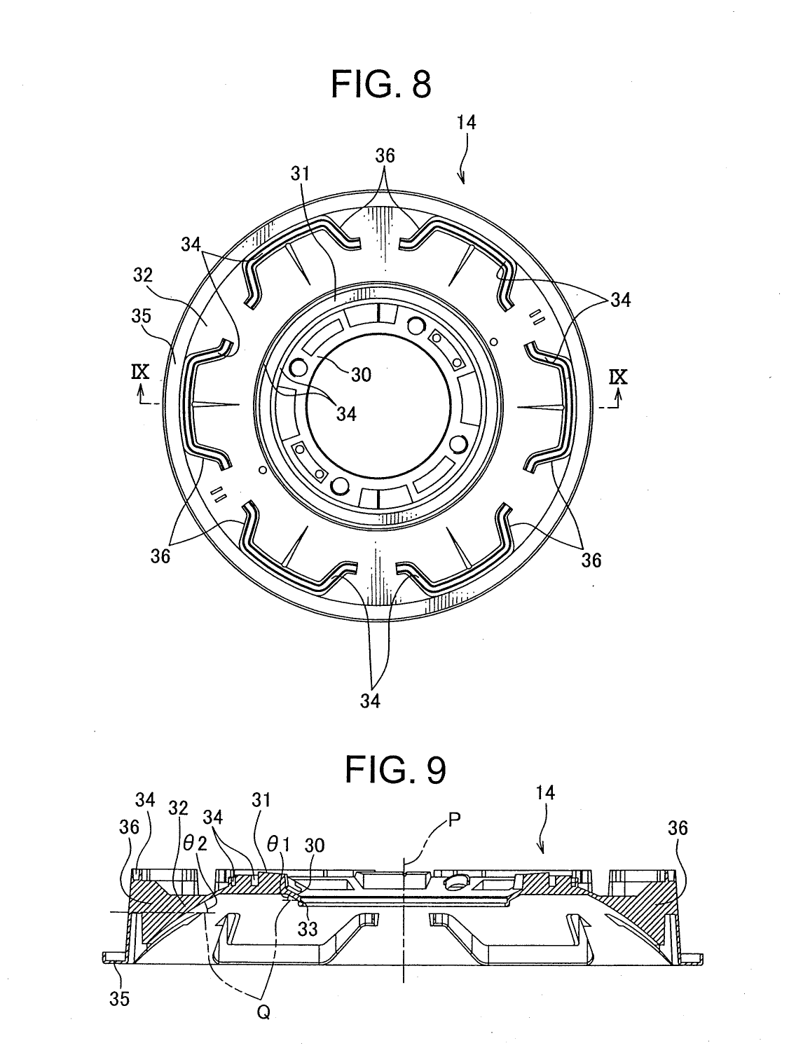

The drive cone 14, as shown in FIGS. 8 and 9, integrally includes an upward extending part 30 as an inner periphery part, a turning part 31 and a downward extending part 32 as an outer periphery part arranged coaxially to each other.

The upward extending part 30 is formed in a cross-section having a plate shape to be inclined gradually in a direction being apart from the magnetic circuit unit 2 toward the outer periphery part of the drive cone. At the inner edge part of the upward extending part 30, an insert tubular part 33 extending raised toward the magnetic circuit unit 2 in the vibrating direction P is provided.

The turning part 31 is formed into a ring shape so as to be continuous to an outer edge part of the upward extending part 30. Both surfaces of the turning part 31 are flat in a direction Q (shown with a tow-dot chain line in FIG. 9) perpendicular to the vibrating direction P. The turning part 31 is provided, at the surface thereof in a side far from the magnetic circuit unit 2, groove for connection with the diaphragm 34, as a support part recessed from the surface. The groove for connection with the diaphragm 34 is formed to be recessed from the surface of the turning part 31 in a cross-section including an axis parallel to the vibrating direction P, so as to extend in a sound emitting direction of the speaker 1. In the embodiment, two grooves for connection with the diaphragm 34 are provided at the turning part 31 and formed into a circular shape in plan view so as to be coaxially to each other. Thus, the grooves for connection with the diaphragm 34 are arranged coaxially with the turning part 31, that is also the drive cone 14, to each other.

The downward extending part 32 is continuous to an outer edge part of the turning part 31. The downward extending part 32 is formed in a cross-section into a plate shape to be inclined gradually in a direction being near to the magnetic circuit unit 2 from the outer edge part of the turning part 31 toward the outer periphery part of the drive cone. At the outer edge part of the downward extending part 32, a mount flange part for mounting 35 flat in the direction Q perpendicular to the vibrating direction P is arranged. As shown in FIG. 7, at the downward extending part 32, a plurality of raised support parts 36 extending raised in the vibrating direction P in a direction being apart from the magnetic circuit unit 2 are provided. At a top end part of the raised support part 36 in a side far from the downward extending part 32, the groove for connection with the diaphragm 34 recessed from the top end part is arranged.

In the cross-section of the above-mentioned drive cone 14, as shown in FIG. 9, an angle θ1 between the upward extending part 30 and the direction Q perpendicular to the vibrating direction P is smaller than an angle θ2 between the downward extending part 32 and the direction Q perpendicular to the vibrating direction P. In addition, in the above-mentioned drive cone 14, as shown in FIG. 9, the inner edge part of the drive cone, that is the inner edge part of the upward extending part 30, is arranged at a position farther from the magnetic circuit unit 2 than a position of the outer edge part of the drive cone, that is the outer edge part of the downward extending part 32. The drive cone 14 configured as mentioned above corresponds to a vibrating body described in claims.

The diaphragm 15 is formed with resin. The diaphragm 15 is formed into a ring shape. An inner diameter of the diaphragm 15 is formed larger than an inner diameter of the drive cone 14, and an outer diameter of the diaphragm 15 is formed larger than an outer diameter of the drive cone 14. As shown in FIG. 1, two projection parts for fixing 37 are provided at an inner edge part of the diaphragm 15 and one projection part for fixing 37 is provided at a middle portion in a radial direction of the diaphragm 15. These projection parts for fixing 37 are formed so as to project from the diaphragm 15 toward the drive cone 14 and formed into a circle shape in plan view and be arranged coaxially to each other.

Each projection part for fixing 37 is arranged in the groove for connection with the diaphragm 34. The diaphragm 15 is fixed to the drive cone 14 by filling a known adhesive configured by resin in the groove for connecting the diaphragm 34. Thus, two projection parts for fixing 37 provided at the inner edge part of the diaphragm 15 is arranged in the grooves for connecting the diaphragm 34 provided at the turning part 31, so that the diaphragm 15 is supported at the grooves 34, in other words, supported at the turning portion 31 of the drive cone 14, that is, supported between the upward extending part 30 and the downward extending part 32. The diaphragm 15 is connected via the edge 17 to the flange part 21 of the frame 4.

The center cap 16 is formed with resin. The center cap 16 is formed into a circular shape in plan view, as shown in FIG. 10. An outer diameter of the center cap 16 is formed larger than the inner diameter of the drive cone 14 and the inner diameter of the diaphragm 15, and smaller than the outer diameter of the drive cone 14 and the outer diameter of the diaphragm 15. An outer edge part of the center cap 16 is placed on the inner edge part of the diaphragm 15 and the outer edge part of the center cap 16 is entirely fixed to the inner edge part of the diaphragm 15 by adhesive. In short, the center cap 16 is supported via the inner edge part of the diaphragm 15 by the turning part 31 of the drive cone 14, and surrounded by the diaphragm 15 in front view of the speaker 1 as shown in FIG. 10.

The edge 17 is formed as a whole into ring shape. And the cross sectional shape is formed with a thin-plate shape and a half arc shape. An outer edge part of the edge 17 is fixed at the flange part 21 of the frame main body 20 by known adhesive. The outer edge part of the edge 17 is sandwiched with the flange part 21 of the frame main body 20 and the gasket 23 and fixed to the flange part and the gasket. An inner edge part of the edge 17 is connected to the outer edge part of the diaphragm 15 by adhesive. Thus, the diaphragm 15 is connected via the edge 17 to the frame main body 20, that is the frame 4.

An outer edge part of the second edge 18 is fixed to the step part 26 of the frame main body 20 by known adhesive. The outer edge part of the second edge 18 is sandwiched between the step part 26 of the frame main body 20 and a fixing member 38 to be mounted to the step part 26 by a screw 39 and fixed to the step part and the fixing member. An inner edge part of the second edge 18 is connected to the flange part 35 of the drive cone 14 by adhesive. Thus, the drive cone 14 is connected via the second edge 18 to the frame main body 20, that is the frame 4.

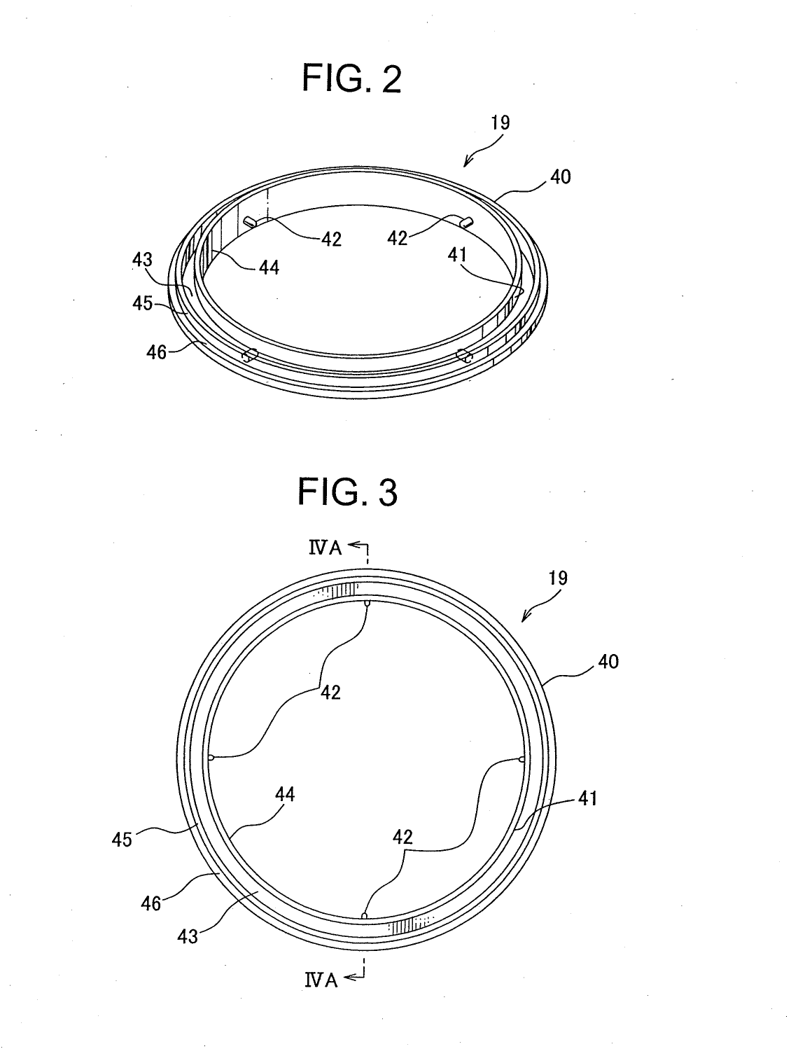

The connecting member for speaker 19, as shown in FIGS. 2 and 3, includes a member main body 40, a U-shaped groove 41 and a plurality of projection part 42. The member main body 40 is formed into a ring shape and connected to the outer face at the above-mentioned other end part of the voice coil bobbin 13. The U-shaped groove 41 is arranged at a surface of the member main body 40 at a side far from the magnetic circuit unit 2. And in the U-shaped groove 41 the tubular part 33, that is the inner edge part of the drive cone 14, is inserted. The projection part 42 projects from an inner face of the member main body 40 toward the voice coil bobbin 13. The connecting member for speaker 19 is made of a material different from both the voice coil bobbin 13 and the drive cone 14.

According to a requirement, the connecting member for speaker 19 is formed with the similar material of one of the voice coil bobbin 13 and the drive cone 14. When the voice coil bobbin 13 and the drive cone 14 are formed with the similar material, the connecting member for speaker 19 may be formed with the similar material of the both. Thus, the material of the connecting member for speaker 19 may be changed suitably.

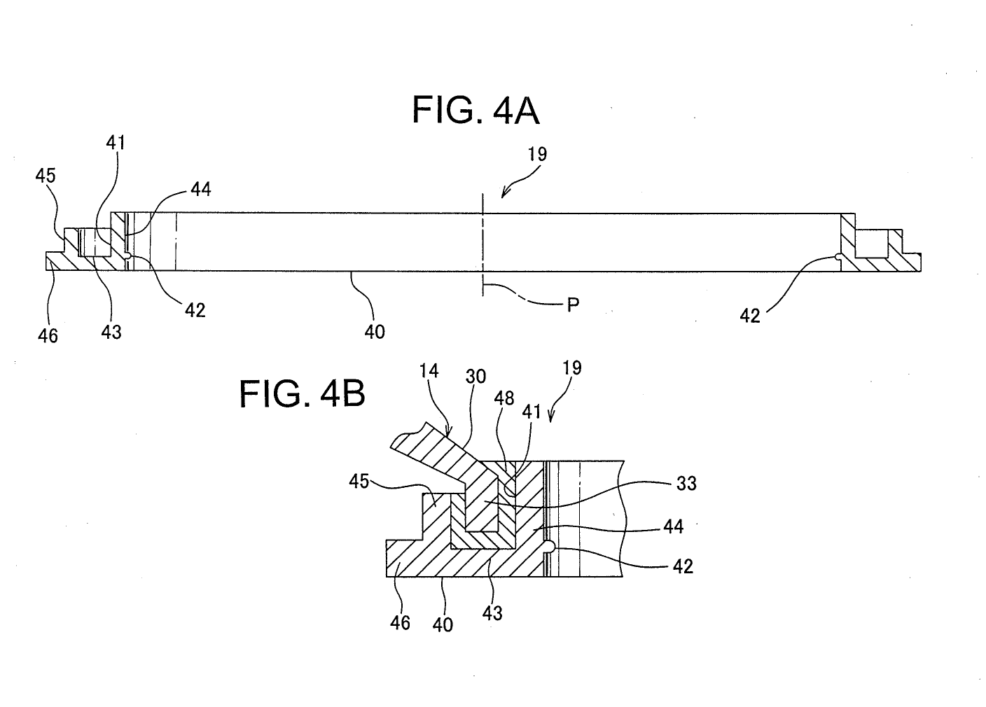

The member main body 40, as shown in FIG. 4A, integrally includes a bottom face part 43 formed into a ring shape; the inner wall part 44 extending raised from an inner edge part of the bottom face part 43; an outer wall part 45 formed into a cylindrical shape and extending raised from an outer edge part of the bottom face part 43; and a flange part 46 formed into a ring shape and extending from the outer edge part of the bottom face part 43 in the outside of the member main body 40. Inner diameters of the bottom face part 43 and the inner wall part 44 are formed slightly larger than the outer diameter of the voice coil bobbin 13. As shown in FIG. 6, known adhesive 47 configured by resin is filled between the outer surface of the voice coil bobbin 13 and the inner wall part 44, so that the inner wall part 44 is connected to the outer face of the other end part of the voice coil bobbin 13 by the known adhesive.

An edge part of the inner wall part 44 at a side far from the bottom face part 43 is arranged at a position farther from the bottom face part 43 than an edge part of the outer wall part 45 at a side far from the bottom face part 43. The flange part 46 projects toward a direction of the outer periphery of the member main body 40 from the outer surface of the outer wall part 45. The flange part 46 is arranged entirely around the member main body 40.

The above-mentioned U-shaped groove 41 is formed so as to be surrounded by the bottom face part 43, the inner wall part 44 and the outer wall part 45. Thus, the U-shaped groove 41 is formed entirely around the member main body 40.

The projection parts 42 are formed projecting from the inner wall part 44 in similar interval in a circumferential direction of the member main body 40. In the embodiment, four projection parts 42 are arranged and interval between projection parts facing to each other are substantially same as the outer diameter of the voice coil bobbin 13.

The known adhesive is an adhesive configured by a resin such as a moisture-curing resin, a two-part type curing resin, a heat curing resin, a photo-curing resin (including UV-curing resin). Two-part type curing resin is preferable to transmit vibration of the voice coil 12 effectively to the drive member (drive cone) 14 and the diaphragm 15. The resin can be silicon-system resin, epoxy-system resin or acryl-system resin may be selected by considering physical characteristic of resin (elastic modulus, internal loss) of the resin.

The adhesive 47 is filled between the inner wall part 44 and the outer face of the coil bobbin 13 from an inside of the connecting member for speaker 19 configured as above mentioned to the other end part of the voice coil bobbin 13. The connecting member for speaker 19 is connected to the voice coil bobbin 13 on condition that the U-shaped groove 41 is open at a side far from the magnetic circuit unit 2 (in the sound emitting direction). The insert tubular part 33, that is the inner edge part, of the drive cone 14 is inserted into the U-shaped groove 41 of the connecting member for speaker 19, and a known adhesive 48 (shown in FIG. 4B) configured by resin is filled in the U-shaped groove 41. Thus, the connecting member for speaker 19 is connected to the drive cone 14 by the adhesive 48 filled in the U-shaped groove 41. Thereby, the drive cone 14 is connected to the voice coil bobbin 13.

The drive cone 14, the diaphragm 15, the center cap 16, the edges 17, 18 and the connecting member for speaker 19 of the above-mentioned vibrating unit 3 are arranged coaxially with the frame 4 and the magnetic circuit unit 2. In the vibrating unit 3, electric current (voice currents) according to voice information is supplied into the voice coil 12, and thereby the voice coil 12 is vibrated along a center axis P (shown with a chain line in FIG. 1, and call a vibrating direction hereafter). The vibration of the voice coil 12 is transmitted through the voice coil bobbin 13 and the drive cone 14 to the diaphragm 15, so that the diaphragm 15 is vibrated in the vibrating direction P so as to emit the sound according to the voice currents.

A space K (correspond to an enclosed space) surrounded by the drive cone 14, the diaphragm 15, the edges 17, 18 and an inner face of the frame main body 20 of the frame 4 as above mentioned is enclosed. In other words, the space K surrounded by the drive cone 14, the diaphragm 15, the edges 17, 18 and the inner face of the frame main body 20 of the frame 4 is maintained to be airtight.

Thereby, in the vibrating unit 3 as above mentioned, when the voice coil bobbin 13 is vibrated in the vibrating direction P, and the drive cone 14 and the diaphragm 15 are vibrated, air in the space K between the drive cone 14 and the diaphragm 15 is compressed and expanded repeatedly by displacements of the drive cone 14 and the diaphragm 15 and the edges 17, 18, so that in the air of the space K spring property as an air spring emerges.

In the embodiment, an effective area of the diaphragm 15 is defined by S1, and an effective area of the drive cone 14 is defined by S2, so a difference between the effective areas S is calculated by S=S1−S2. If Air volume in the enclosed space K between the drive cone 14 and the diaphragm 15 is defined by V, stiffness indicating spring property of the air spring is in proportion to S/V. According to the embodiment, with the spring property as the air spring developed by the air in the space K enclosed between the drive cone 14 and the diaphragm 15, it is possible that abnormal performance such a movement of the diaphragm 15 with very large amplitude of vibration can be prevented and acoustic characteristic of the speaker 1 can be reproduced for a long period, and when the diaphragm 15 is vibrated with large amplitude of vibration in a long period, the reliability of the speaker 1 can be maintained.

In the speaker 1 configured as mentioned above, voice currents is supplied to the voice coil 12, and the voice coil 12 arranged in the magnetic gap G is vibrated along the center axis, that is the vibrating direction P, according to the voice currents. Thereby, the voice coil bobbin 13, of which the voice coil 12 is wound around the outer periphery, is vibrated together with the drive cone 14 and the diaphragm 15 along the center axis, that is the vibrating direction P. In short, the vibration of the voice coil 12 is transmitted to the diaphragm by the drive cone 14, so that by the diaphragm 15 vibrating, the audio sound is emitted according to the voice currents. Thus, the magnetic circuit unit 2 vibrates the diaphragm 15, that is the vibrating unit 3, so as to generate sound.

According to the embodiment, the connecting member for speaker 19 is provided with the U-shaped groove 41, in which the insert tubular part 33, that is the inner edge part, of the drive cone 14 is inserted. Therefore, the thickness of the inner wall part 44 can be formed thicker than ever before, and the connecting area between the inner edge part of the drive cone 14 and the connecting member for speaker can be increased. Thereby, the connecting member for speaker 19 can be prevented from peeling from both of the voice coil bobbin 13 and the drive cone 14, so that the vibration of the voice coil bobbin 13 can be securely transmitted to the drive cone 14.

In addition, the projection parts 42 projecting from the inner wall part 44, that is the inner face, of the member main body 40having the U-shaped groove 41 toward the voice coil bobbin 13 are arranged in similar interval on the circumferential direction of the member main body 40. Thereby, the connecting member for speaker 19 can be connected to the voice coil bobbin 13 in condition that the connecting member for speaker 19 and the voice coil bobbin 13 are arranged coaxially to each other. Thus, the connecting member for speaker 19 can be connected to the voice coil bobbin 13 without inclination against the voice coil bobbin 13.

In addition, a height of the inner wall part from the bottom face part 43 of the member main body 40 is formed higher than a height of the outer wall part 45 from the bottom face part 43. Thereby, the connecting area between the inner wall part 44 of the member main body 40 and the voice coil bobbin 13 can be increased, so that the connecting member for speaker 1 can be connected more securely to the voice coil bobbin 13. Oppositely, the outer wall part 45 is formed lower than the inner wall part 44. Even when the inner edge part of the drive cone 14 is deformed after the drive cone 14 and the diaphragm 15 as the vibrating body vibrating on driving the speaker 1, it can be prevented that the drive cone 14 and the connecting member for speaker 19 are contacted to each other at a position other than in the U-shaped groove 41. Therefore, the thin shape speaker 1 can be provided.

In addition, the flange part 46 extending in a direction of the outer periphery part from the outer edge part of the bottom face part 43 so as to project from the outer face of the outer wall part 45 is provided. Thereby, stiffness of the member main body 40, that is the connecting member for speaker 19, can be increased. The connecting member for speaker 1 is not deformed on vibrating, so that the vibration of the voice coil bobbin 13 can be securely transmitted to the drive cone 14. In case that the speaker 1 is in an abnormal condition, the flange part 46 may contact easily to the magnetic circuit unit 2 and the frame 4. When the flange part 46 contacts the magnetic circuit unit 2 or the frame 4, abnormal sound is generated, and this abnormal sound can alert a user.

The speaker 1 includes the connecting member for speaker 19 configured as mentioned above. In the speaker 1, the lead wires 28 from the inner wall part 44, that is inner face, of the member main body 40 of the connecting member for speaker 19 is passed between the projection parts 42, and between the outer face of the voice coil bobbin 13 and the inner wall part 44 of the connecting member for speaker 19. The voice coil 12 is arranged at the one end part of the voice coil bobbin 13, and the lead wires 28 are led toward the other end part of the voice coil bobbin, that is toward the connecting member for speaker 19. Therefore, the connecting member for speaker 19 can be prevented from easily peeling the connecting member for speaker 19 from both the voice coil bobbin 13 and the drive cone 14, so that the vibration of the voice coil bobbin 13 can be transmitted securely to the drive cone 14.

The inner wall part 44 of the connecting member for speaker 19 and the outer face of the voice coil bobbin 13 is connected by the known adhesive formed with resin. In the case, the voice coil bobbin 13 and the connecting member for speaker 19 can be securely configured by different components, so that the Joule heat generated by the voice coil 12 cannot be easily transmitted to the drive cone 14. Furthermore, by applying known adhesive having relatively small heat conductivity, the Joule heat is prevented from easily transmitting to the drive cone 14. Therefore, connection strength between the connecting member for speaker 19 and the drive cone 14 can be maintained.

The through hole 29 is provided between the voice coil 12 of the voice coil bobbin 13 and the connecting member for speaker 19. Therefore, the voice coil 12 and the voice coil bobbin 13 can be cooled by air through the through hole 29. Thereby, the Joule heat generated by the voice coil 12 is prevented from transmitting to the drive cone 14. Therefore, connection strength between the voice coil bobbin 13 and the connecting member for speaker 19 and connection strength between the connecting member for speaker 19 and the drive cone 14 can be maintained.

The connecting member for speaker 19 is formed with a material different from materials of the drive cone 14 and the voice coil bobbin 13. Therefore, the Joule heat generated by the voice coil 12 is prevented from transmitting to the connecting member for speaker 19 and the drive cone 14, so that connection strength between the voice coil bobbin 13 and the connecting member for speaker 19 and connection strength between the connecting member for speaker 19 and the drive cone 14 can be maintained.

The connecting member for speaker 19 and the drive cone 14 are connected by the adhesive 47 filled in the U-shaped groove 41. Thereby, the connecting member for speaker 19 and the drive cone 14 can be more securely connected to each other.

The drive cone 14 is connected to the connecting member for speaker 19. Thereby, the drive cone 14 and the connecting member for speaker 19 can be more securely connected.

The magnetic circuit unit 2 is configured by the plate 9, the magnet 8 and the yoke 7. Thereby, the magnetic circuit unit 2 can securely vibrate the drive cone 14.

The diaphragm 15 is supported by the drive cone at an area between the upward extending part 30 and the downward extending part 32 of the drive cone 14. Thereby, the vibration of the voice coil bobbin 13 can be transmitted via the drive cone 14 to the diaphragm 15.

The inner edge part of the drive cone 14 is arranged at the position farther from the magnetic circuit unit 2 than the outer edge part of the drive cone 14. Thereby, the interval between the outer edge part of the drive cone 14 and the diaphragm 15 can be increased, so that amplitude of vibration of the diaphragm 15 can be increased.

The diaphragm 15 is supported at the turning part 31 arranged between the upward extending part 30 and the downward extending part 32 of the drive cone 14, and formed flat in the direction perpendicular to the vibrating direction P. Thereby, the vibration of the voice coil bobbin 13 can be securely transmitted to the diaphragm 15 via the drive cone 14.

The angle θ1 between the upward extending part 30 of the drive cone 14 and the direction Q perpendicular to the vibrating direction P is smaller than the angle θ2 between the downward extending part 32 and the direction Q perpendicular to the vibrating direction P. Therefore, total thickness of the upward extending part 30 and the magnetic circuit unit 2 overlapped on the upward extending part 30 in the vibrating direction P can be formed smaller, so that the speaker 1 can be made thinner.

The center cap 16 surrounded by the diaphragm 16 and supported at the outer edge part thereof supported by the turning part 31 is provided. Thereby, the center cap can be prevented that the voice coil bobbin 13 is exposed, so that an inside of the voice coil bobbin may be prevented from being attached to dust.

In the speaker 1, the space K between the drive cone 14 and the diaphragm 15 is sealed. Thereby, vibration energy of the voice coil bobbin 13, the drive cone 14 and the diaphragm 15 is absorbed by spring property as the air spring emerged by the air in the space K so as to decrease the vibration of the voice coil bobbin 13. Therefore, a damper which is provide at a conventional speaker is not required. In other words, in the speaker 1 according to the embodiment, the drive cone 14 and the diaphragm 15 also double with the damper decreasing the vibration of the drive cone 14, the diaphragm 15 and voice coil bobbin 13. Therefore, the damper supporting the voice coil 13 at a rear side of the drive cone 14 and the diaphragm 15 is not required. Then, a dimension along the axis can be shortened by eliminating the damper and a mount space for the damper, so that the speaker 1 can be made thinner so as to meet the requirement for an audio system mounted in a vehicle.

For achieving the enclosed space K between the drive cone 14 and the diaphragm 15, the drive cone 14 arranged coaxially at a rear side of the diaphragm 15 can be formed with the common material as the diaphragm 15. Comparing a conventional damper having a bellows structure, mechanical fatigue is not easily generated, so that deterioration of reliability of the speaker unit caused by the mechanical fatigue of the component is prevented and extending more a life time of the speaker 1 can be achieved.

The damper having the bellows structure (corrugate damper) is deformed in a direction perpendicular to the center axis of the voice coil so as to prevent a rolling vibration (movement in the direction perpendicular to the center axis of the voice coil) of the vibrating unit such as the voice coil, voice coil bobbin and the diaphragm. However, no large local deformation occurs at the drive cone 14 and the diaphragm 15, so that an abnormal vibration on rolling phenomenon causing noisy sound or rustling sound generated by the voice coil bobbin 13 contacting with the plate 9 and the magnet 8 are not generated and noiseless high-quality sound can be reproduced.

In the speaker 1 according to the embodiment, when the diaphragm 15 is vibrated, the air in the space K enclosed between the drive cone 14 and the diaphragm 15 is repeatedly compressed and expanded, so that the drive cone 14 and the edges 17, 18 of the diaphragm 15 can be prevented from deformation by air pressure received at rear surfaces thereof (back pressure). Therefore, the abnormal vibration and the rustling sound mentioned above are not generated, so that the drive cone 14 and the diaphragm 15 can be vibrated with large amplitude of vibration and sound can be reproduced in large volume. Abnormal behavior such as motion of the diaphragm 15 with very large amplitude of vibration can be prevented by the air spring emerged by the air in the space K. The acoustic characteristic of the speaker 1 can be reproduced in a long period. When the diaphragm 15 is vibrated at large amplitude of vibration for a long period, the reliability of the speaker 1 can be maintained.

### Second Embodiment

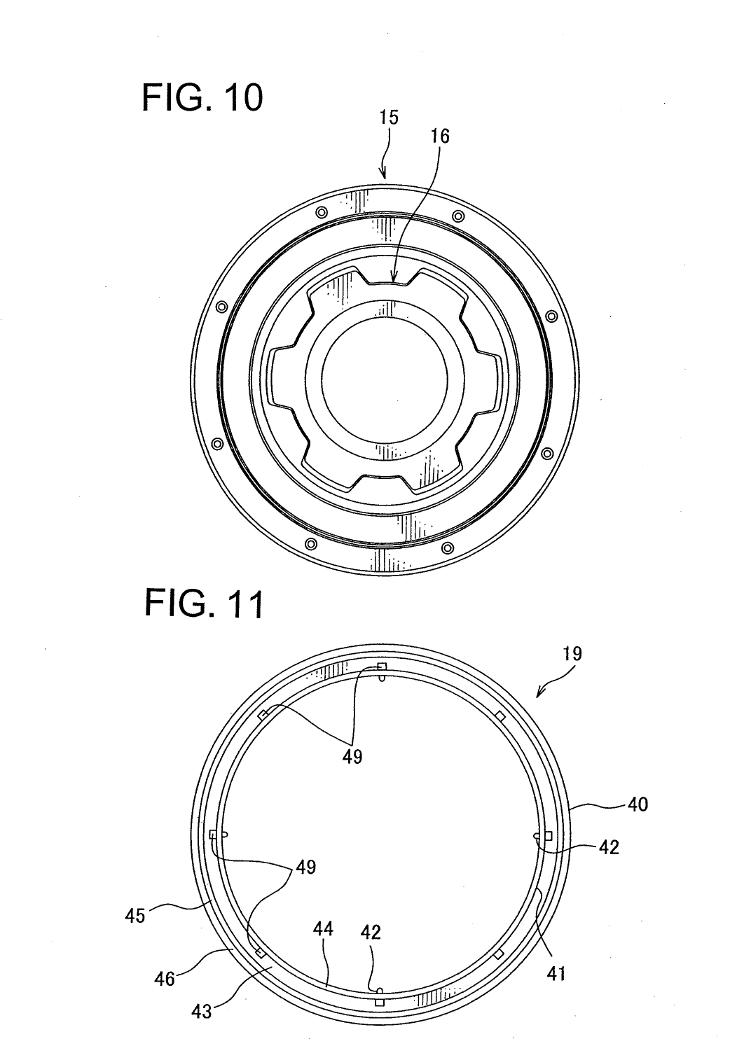

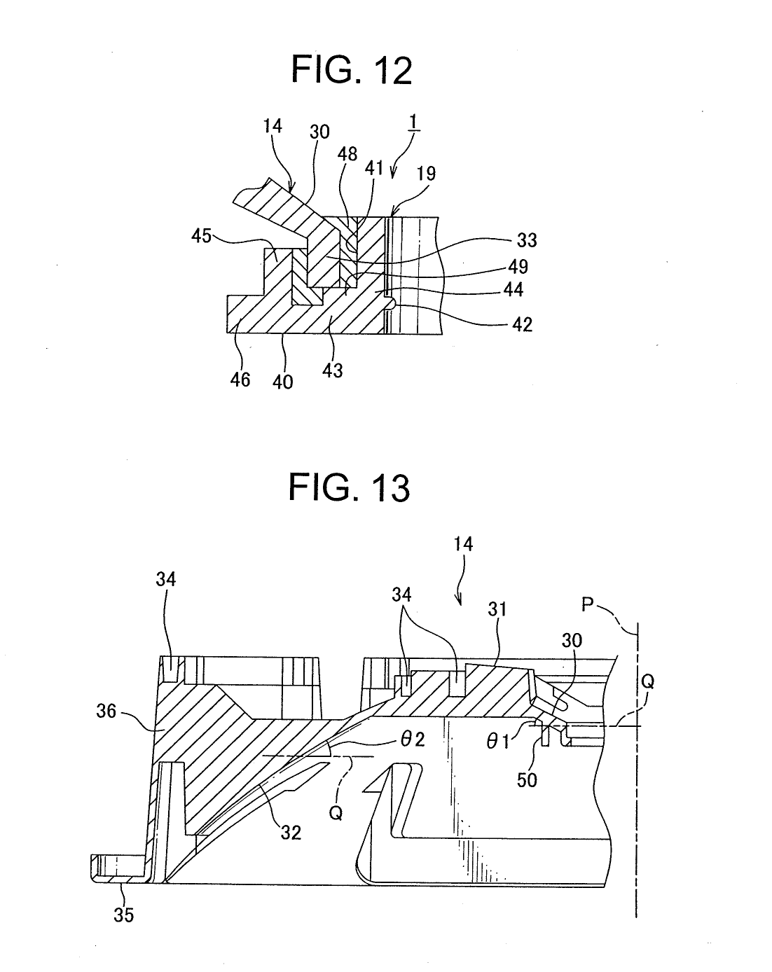

The second embodiment of the present invention is described with reference to FIGS. 11 and 12. The same components as the first embodiment will be marked with the same marking, and the explanation is omitted.

In the embodiment, as shown in FIGS. 11 and 12, a plurality of projection parts 49 is provided in the U-shaped groove 41 of the connecting member for speaker 19. The projection parts 49 are arranged in interval in the circumferential direction of the member main body 40 of the connecting member for speaker 19. The projection part 49 is formed projecting from the surfaces of the bottom face part 43 and the inner wall part 44, and a height of the projection part 49 from the bottom face part 43 is formed lower than height of the projection part from the inner wall part 44 and the height of the projection part from the outer wall part 45. According to the embodiment, even when amount of the adhesive 48 filled in the U-shaped groove 41 is reduced, the connecting member for speaker 19 can be connected securely to the drive cone 14 as the vibrating body by the adhesive.

### Third embodiment

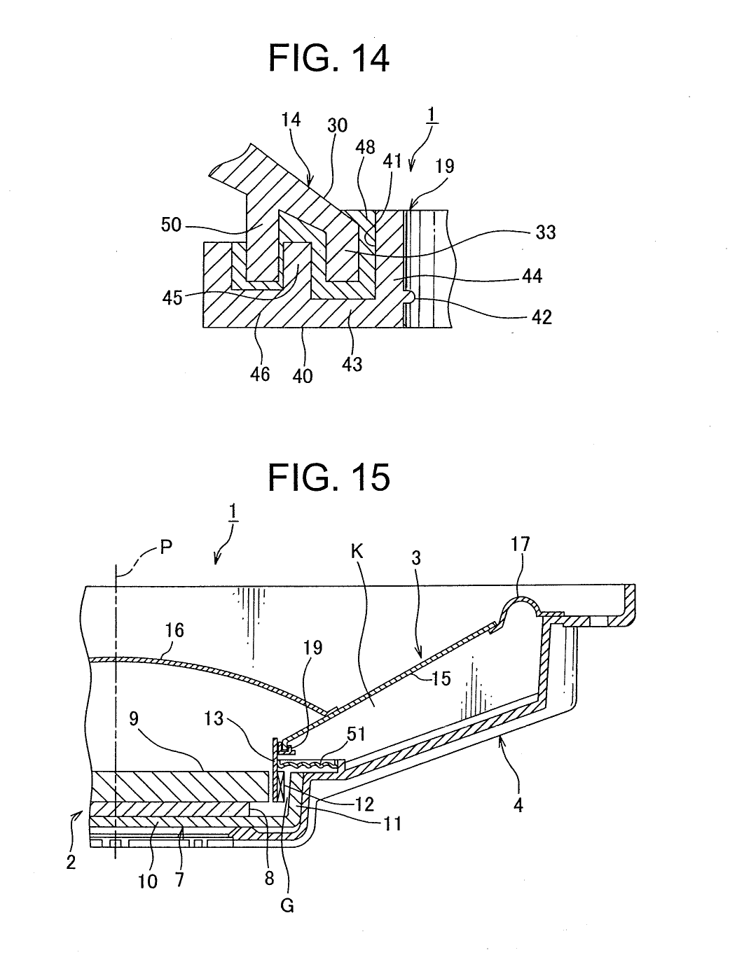

The third embodiment of the present invention is described with reference to FIGS. 13 and 14. The same components as the first embodiment will be marked with the same marking, and the explanation is omitted.

According to the embodiment, as shown in FIGS. 13 and 14, an outer tubular part 50 positioning the outer wall part 45 of the connecting member for speaker 19 between the insert tubular part 33 and the outer tubular part 50 is provided at outer periphery of the insert tubular part 33 arranged at the inner edge part of the upward extending part 30 of the drive cone 14. The outer tubular part 50 is formed projecting from the upward extending part 30 toward the connecting member for speaker 19 and is formed into a cylindrical shape coaxially with the insert tubular part 33.

According to the embodiment, the outer wall part 45 of the connecting member for speaker 19 is positioned between the insert tubular part 33 and the outer tubular part 50, so that contact area between the connecting member for speaker 19 and the drive cone 14 can be larger and the connecting member for speaker 19 and the drive cone 14 can be connected more securely.

According to first, second and third embodiments, an air-suspension speaker including enclosed space K instead of a damper is exampled. The present invention can be applied to the speaker 1 including a damper 51 and not enclosing the space K as shown in FIG. 15. The components in FIG. 15 same as the above-mentioned embodiment will be marked with the same marking, and the explanation is omitted. In the speaker 1 shown in FIG. 15, the diaphragm 15 corresponds to the vibrating body described in claim of the present invention. In the case shown in FIG. 15, the connecting member for speaker 19 is provided with the above-mentioned U-shaped groove 41, so that the connecting member for speaker 19 and the diaphragm 15 can be connected more securely to each other. Thereby, it can be prevented that the connecting member for speaker 19 is easily peeled from both the voice coil bobbin 13 and the diaphragm 15, so that the vibration of the voice coil bobbin 13 can be securely transmitted to the diaphragm 15.

In the above-mentioned first, second and third embodiment, the height of the inner wall part 44 of the member main body 40 from the bottom face part 43 is formed higher than the height of the outer wall part 45 from the bottom face part 43. Thereby, the connecting area between the inner wall part 44 of the member main body 40 and the voice coil bobbin 13 can be increased, so that the connecting member for speaker 1 can be more securely connected to the voice coil bobbin 13. In other words, the outer wall part 45 is formed lower than the inner wall part 44, so that, in case that the vibrating body is vibrated on driving the speaker 1 and the inner edge part of the drive cone 14 is deformed, it can be prevented that the drive cone 14 and the connecting member for speaker 19 are contacted at a position other than the area in the U-shaped groove 41. Therefore, a thin speaker 1 can be provided.

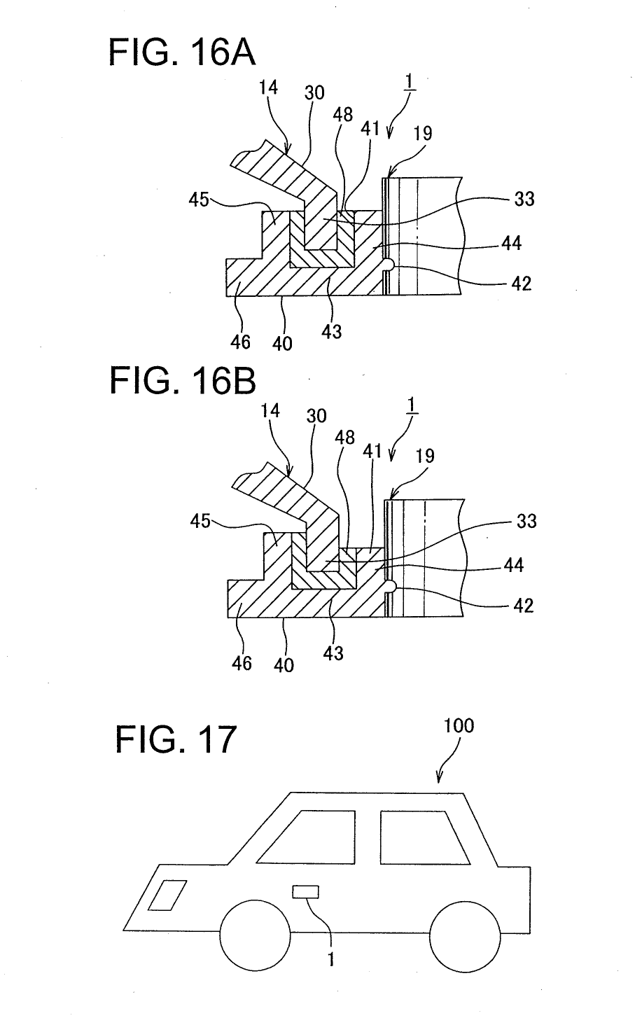

As modifications of the connecting member for speaker 19 shown in FIG. 4, the height of the inner wall part 44 is substantially formed equal to the height of the outer wall part 45 as shown in FIG. 16A, or lower than the height of the outer wall part 45 as shown in FIG. 16B. In case that the height of the inner wall part 44 is substantially formed equal to the height of the outer wall part 45, heights of the adhesive 48 at an inside and an outside of the insert tubular part 33 of the drive cone 14 can substantially be equal, so that the connecting area between the insert tubular part 33 and the connecting member for speaker 19 can be relatively increased at an inside and an outside of the insert tubular part 33. Therefore, the drive cone 14 can be securely fixed at the connecting member for speaker 19.

In case that the height of the inner wall part 44 of the connecting member for speaker 19 is formed higher than the height of the outer wall part 45 so as not to contact to the drive cone 14, the height of adhesive 48 at the outside of the insert tubular part 33 of the drive cone 14 can be formed relatively higher and it can be prevented that the adhesive 48 flows outside the outer wall part 45. The connecting area between the insert tubular part 33 and the connecting member for speaker 19 can be made large comparatively at the outside of the insert tubular part 33. Therefore, the drive cone 14 can be securely fixed at the connecting member for speaker 19.

According to the above embodiments, the following connecting member for speaker can be provided.

Additional Remark: A connecting member for speaker 19, connecting a drive cone 14 vibrated with a magnetic circuit unit 2 to a voice coil bobbin 13 supporting a voice coil 12, includes: a member main body 40 formed into a annular shape and connected to at an outer face of the voice coil bobbin 13; and a U-shaped groove 41 arranged at the member main body 40, in which an inner edge part of the vibrating body is arranged.

According to the additional remark, the connecting member for speaker 19 is provided with the U-shaped groove 41, in which the insert tubular part 33, that is the inner edge part, of the drive cone 14. Therefore, the thickness of the inner wall part 44 of the connecting member for speaker 19 to be connected to the voice coil bobbin 13 can be thicker than the conventional thickness, and the connecting area between the inner edge part of the drive cone 14 and the connecting member for speaker can be increased. Therefore, it can be prevented that the connecting member for speaker 19 is easily peeled from both the voice coil bobbin 13 and the drive cone 14, and the vibration of the voice coil bobbin 13 can be securely transmitted to the drive cone 14.

It is not intended herein to mention all the possible embodiments of the invention which will be apparent to those skilled in the art. It is understood that the term used herein are merely descriptive rather than limiting, in that various changes may be made without departing from the scope of this invention.

1. A connecting member for speaker, connecting a vibrating body vibrated with a magnetic circuit unit to a voice coil support part supporting a voice coil, comprising:
a member main body formed into a annular shape and connected to an outer face of the voice coil support part; and
a U-shaped groove arranged at the member main body, in which an inner edge part of the vibrating body is arranged.

2. The connecting member for speaker according to claim 1, wherein the member main body includes:
a bottom face part formed into a annular shape;
an inner wall part extending and raised from an inner edge part of the bottom face part; and
an outer wall part extending vertically from an outer edge part of the bottom face part,
wherein the U-shaped groove is formed so as to be surrounded by the bottom face part, the inner wall part and the outer wall part,
wherein an end part of the inner wall part in a side far from the bottom face part is arranged at a position farther than an end part of the outer wall part in aside far from the bottom face part.

3. The connecting member for speaker according to claim 2, comprising a flange part extending in a direction toward an outer periphery part of the member main body from the outer edge part of the bottom face part so as to project from the outer wall part in a direction toward an outer periphery part of the member main body.

4. A speaker comprising:
a frame;
a magnetic circuit unit supported by the frame;
a voice coil;
a voice coil support part supporting the voice coil;
a vibrating body supported by the frame and vibrated with the magnetic circuit unit; and
a connecting member for speaker connecting the vibrating body to the voice coil support part,
wherein the connecting member for speaker according to claim 3 is applied for the connecting member for speaker.

5. The speaker according to claim 4, wherein the connecting member for speaker comprises a projection part projecting from an inner face of the member main body toward the voice coil support part.

6. The speaker according to claim 5, wherein the connecting member for speaker comprises a plurality of projection parts arranged in intervals in a circumferential direction of the member main body, and a lead wire led from the voice coil passes between the projection parts.

7. The speaker according to claim 6, wherein the lead wire passes between an outer face of the voice coil support part and the inner wall part.

8. The speaker according to claim 7, wherein the voice coil is supported at one end of the voice coil bobbin, and the connecting member for speaker is connected to the other end of the voice coil support part, and the lead wire is led from the voice coil toward the connecting member for speaker.

9. The speaker according to claim 8, wherein the inner wall part of the connecting member for speaker and the outer face of the voice coil support part are connected to each other by adhesive.

10. The speaker according to claim 9, wherein a through hole is formed at the voice coil support and between the voice coil and the connecting member for speaker.

11. The speaker according to claim 10, wherein the connecting member for speaker is constructed by a material different from both of the voice coil support part and the vibrating body.

12. The speaker according to claim 11, wherein the connecting member for speaker and the vibrating body are connected to each other by adhesive filled in the U-shaped groove.

13. The speaker according to claim 12, comprising:
a diaphragm vibrated with the magnetic circuit unit as the vibrating body;
an edge supporting the diaphragm at the frame; and
a damper supporting the diaphragm at the frame, wherein the diaphragm is a part of the vibrating body.

14. The speaker according to claim 12, comprising:
a diaphragm vibrated with the magnetic circuit unit;
an edge supporting the diaphragm at the frame;
a drive member transmitting vibration of the voice coil to the diaphragm; and
a second edge supporting the drive member at the frame, wherein the drive member is a part of the vibrating body.

15. The speaker according to claim 12, wherein the magnetic circuit unit includes:
a yoke constructed by a magnetic body;
a magnet arranged on the yoke; and
a plate constructed by a magnetic body and arranged on the magnet.

16. The speaker according to claim 14, wherein the diaphragm is supported by the drive member between an inner periphery part of the drive member and an outer periphery part of the drive member.

17. The speaker according to claim 16, wherein an inner edge part of the drive member is arranged at a position farther from the magnetic circuit unit than an outer edge part of the drive member.

18. The speaker according to claim 17, wherein the drive member includes a turning part being flat in a direction perpendicular to a vibration direction of the drive member and being arranged between the inner periphery part and the outer periphery part of the drive member, and the diaphragm is supported by the turning part.

19. The speaker according to claim 18, wherein the inner periphery part of the drive member is formed to be an upward extending part inclined in a direction apart from the magnetic circuit unit toward an outside thereof, and the outer periphery part of the drive member is formed to be a downward extending part inclined in a direction close to the magnetic circuit unit toward an outside thereof, wherein an angle between the upward extending part and the direction perpendicular to the vibration direction of the drive member is configured smaller than an angle between the downward extending part and the direction perpendicular to the vibration direction of the drive member.

20. The speaker according t claim 19, comprising a second diaphragm surrounded by the diaphragm, wherein the second diaphragm has an outer edge part supported by the turning part.

21. The speaker according to claim 20, wherein the drive member includes a support portion arranged at the turning part and extending in an acoustic wave emitting direction, wherein the diaphragm is supported by the support portion.

22. The speaker according to claim 20, wherein an enclosed space is formed between the diaphragm, the drive member and the frame.

23. A moving body comprising the speaker according to claim 4.
